(19) United States
(12) Patent Application Publication
(10) Pub. No.: US 2024/0351481 A1
(43) Pub. Date: Oct. 24, 2024

(54) Seat Belt Alarm System

(71) Applicant: Yonas Muluneh, Reno, NV (US)

(72) Inventor: Yonas Muluneh, Reno, NV (US)

(21) Appl. No.: 18/137,238

(22) Filed: Apr. 20, 2023

(51) Int. Cl. B60N 2/00; B60R 21/015; G08B 21/02; G08B 21/24

(52) U.S. Cl. CPC B60N 2/002; B60R 21/01546; G08B 21/0205; G08B 21/24

(57) ABSTRACT

Kids Safety is the only product of its kind that uses a phone app possessing signal connections to a buckle sensor in order to alert and remind parents that their child is in the vehicle and/or has been left behind. This unprecedented device is uniquely designed with durable, high-quality materials to ensure long-term sustainability and complete functionality, regardless of the car make or model the system is employed in post-build.

### BACKGROUND

In today's busy times, any parent or caregiver is capable of forgetting a child is present in the backseat of a vehicle as a result of them moving remotely, under the circumstance of routine. Leaving a child in the backseat can cause heat-related illnesses and, in extreme cases, may even lead to death due to the lack of air circulation. There have been no products available as original equipment or as an aftermarket to address this problem.

An apparatus the reminds caregivers that a child is present in the backseat of the vehicle, is not being met by any known device or system at present. There have been no products available as original equipment or as an aftermarket to address this problem either.

### SUMMARY OF THE INVENTION

The main purpose of the disclosure is to provide users with a Bluetooth alarm system in vehicles that reminds parents to tend to their infant/children before exiting the automobile.

A seat belt alarm system for a vehicle, the system including a voltage level circuit connected to a battery of the vehicle and configured to trigger in response to a predetermined fluctuation in a voltage across the battery indicative of an alternator running charge of the battery. The disclosure also includes a buckle for the seat belt configured in a closed circuit including the buckle, a tongue of the buckle, the voltage level circuit and the battery and in an open circuit based on the tongue outside the buckle. The disclosure further includes an alarm configured active in response to the trigger and a closed circuit and inactive in response to an inactive trigger and an open circuit to indicate an ignition status of the vehicle and a status of the buckle and tongue.

### BRIEF DESCRIPTION OF THE DRAWINGS

FIG. 1 is a left perspective view of the Seat belt Alarm System in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

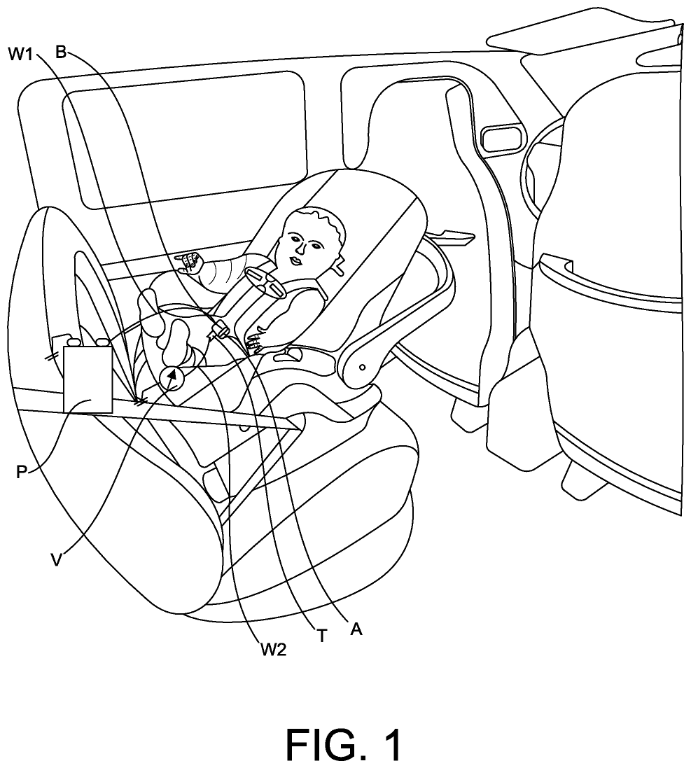

FIG. 1 is a left perspective view of seat belt alarm system showing: a buckle B with a control circuit and/or sensor and a Bluetooth alarm; an alarm A which is active, ie goes off when the vehicle ignition stops and the buckle B is still fastened to the seat belt tongue referenced as T, in an engine compartment and inside cabin wiring W1 and W2 respectively to car battery P to include or not a USB port, and a voltage level circuit V triggered by a predetermined fluctuation in a voltage level of the vehicle battery P indicative of a running alternator in accordance with an embodiment of the present disclosure. The alarm A includes an audible alarm and wireless alarm signals to predetermined cell phones and emergency and law enforcement agencies as appropriate and as disclosed herein.

The present disclosed seat belt alarm system, also known as “Kids Safety”, offers a modern device that signals an alarm when the vehicle's ignition stops, and the buckle is still fastened, to prevent the fatal consequence of leaving a child unattended. Expanding on the initial design of a car seat buckle, Kids Safety introduces a novel sensor located on the buckle that works in complement with a mobile application that automatically sounds an alarm to remind parents that their infant is in the vehicle, in addition to, sending push notifications to their cellular device after an allotted time frame. Once the key from the ignition is out and the child's seat belt buckle is still fastened, parents will have a couple of minutes to unbuckle the child's seat belt. In the case that the seat remains buckled after ten minutes, notifications will automatically be sent to the connected mobile device. If users to not respond after twenty minutes have passed, Kids Safety app will inform local authorities that a child is alone in the vehicle, providing the location data to such authorities as support assistance. To further enhance functionality, this avant-garde product is connected to the vehicle battery directly or through the interior wiring of the vehicle or through an USB (universal serial bus) connection inside a cabin of the vehicle and therefore does not require any extra battery to function. With Kids Safety, parents will have a constant, reliable reminder that their infant is in the backseat and must be taken out to prevent deadly consequences.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A seat belt alarm system for a vehicle, the system comprising:
a voltage level circuit connected to a battery of the vehicle and configured to trigger in response to a predetermined fluctuation in a voltage across the battery indicative of an alternator running charge of the battery;
a buckle for the seat belt configured in a closed circuit including the buckle, a tongue of the buckle, the voltage level circuit and the battery and in an open circuit based on the tongue outside the buckle; and
an alarm configured active in response to the trigger and a closed circuit and inactive in response to an inactive trigger and an open circuit to indicate an ignition status of the vehicle and a status of the buckle and tongue.

2. The system of claim 1, wherein the wireless communication is a Bluetooth® communication.

3. The system of claim 1, wherein a wiring of the circuit is a direct wiring there between.

4. The system of claim 1, wherein a wiring of the voltage level circuit to the buckle is an inside cabin wiring.

5. The system of claim 1, wherein a wiring of the voltage level circuit to the battery of the vehicle is an engine wiring.

6. The system of claim 1, wherein a wiring of the voltage level circuit to the buckle is an inside USB (Universal Serial Bus) wiring.

7. The system of claim 1, further comprising a timing circuit configured to trigger a subsequent alarm after a predetermined time from the trigger.

8. The system of claim 7, wherein the predetermined time is ten minutes.

9. The system of claim 7, wherein the subsequent alarm is a wireless signal sent from the timing circuit to a predetermined cell phone.

10. The system of claim 7, wherein the timing circuit is configured to trigger a second subsequent alarm after a second predetermined time from the trigger.

11. The system of claim 10, wherein the second predetermined time is twenty minutes.

12. The system of claim 10, wherein the second subsequent alarm is a wireless signal automatically sent from a predetermined cell phone to an emergency service provider.

13. The system of claim 10, wherein the second subsequent alarm is a wireless signal automatically sent from a predetermined cell phone to a law enforcement agency.

14. The system of claim 1, wherein the alarm is an audible alarm.

15. The system of claim 1, wherein the alarm is an audible alarm automatically sounded from a predetermined cell phone.
